(19) United States
(12) Patent Application Publication
(10) Pub. No.: US 2025/0061215 A1
(43) Pub. Date: Feb. 20, 2025

(54) METHOD AND APPARATUS FOR ENCRYPTING SELECTED PORTION OF FILE

(71) Applicant: Khee Seng CHUA, Melbourne (AU)

(72) Inventor: Khee Seng CHUA, Melbourne (AU)

(21) Appl. No.: 18/937,930

(22) Filed: Nov. 5, 2024

Related U.S. Application Data
(63) Continuation-in-part of application No. 17/284,829, filed on Apr. 13, 2021, now Pat. No. 12,164,665.
(60) Provisional application No. 62/745,368, filed on Oct. 14, 2018.

(51) Int. Cl. G06F 21/62; G06F 21/60

(52) U.S. Cl. CPC G06F 21/6209; G06F 21/602; G06F 21/604

(57) ABSTRACT

A method and system for selectively encrypting and decrypting portions of a file are disclosed. The system may extract a chosen part from a document, spreadsheet, presentation, or PDF file, and replace the chosen part with user-defined text or pixels, and also encrypt the extracted selection using a user-defined password. The encrypted data may be stored in a non-viewable or non-printable area of the file, such as metadata or a Visual Basic Module. For decryption, the system may retrieve the encrypted selection, decrypt it using the password, and replace the user-defined text or pixels with the original content. The method may enable a partial encryption of sensitive information while maintaining the overall coherence and searchability of the file.

### CROSS REFERENCE TO RELATED APPLICATION

The application is a continuation-in-part of U.S. patent application Ser. No. 17/284,829 filed on Apr. 13, 2021, which is a United States National Stage Application of PCT/IB2019/058540, filed on Oct. 8, 2019, which claims the benefit of U.S. provisional application No. 62/745,368, filed on Oct. 14, 2018, the entire contents of these applications are incorporated by reference.

### TECHNICAL FIELD

The application relates to file processing, in particular, to method and apparatus for encrypting a selected portion of a file.

### BACKGROUND

As devices such as mobile phones and digital cameras become more prevalent in everyday lives, sensitive documents and images are usually stored on the phone or computer or other storage devices.

This poses a security risk should the data fall into the wrong hands as the sensitive documents can be used for blackmail, identity theft or a source of embarrassment.

Presently, there are many software which offers encryption of documents or images. However, all of these software encrypts the document or image in its entirety. This makes the document or image incomprehensible unless it has been decrypted.

As the encrypted document does not make any sense, keyword searches cannot be performed on it. Encrypted image cannot be viewed at all without first decrypting the image.

Thus, for example, if a user is scrolling through the Camera Roll on his phone, the encrypted image would not be viewable without first decrypting it. This makes it tedious for the user to find the image he wants as he first has to guess which image is the one he wants, decrypt it and view it. If the image is not the one he wants, he needs to make another guess, decrypt it and view it and so on.

### SUMMARY OF INVENTION

The present disclosure proposes a method and an apparatus to solve at least one of the technical problems as mentioned above, in which only sensitive portions of the document or image is encrypted, thereby allowing the document or image to be coherent yet protecting the sensitive portions of it from prying eyes.

In one aspect of the present application, a method for processing a file comprises: selecting a portion of the file to be encrypted; encrypting the selected portion of the file as encrypted data; and amending the file by replacing the selected portion with predefined data and appending the encrypted data at an end of the file.

According to an embodiment, the portion of file may be automatically selected according to a predefined rule or manually selected by a user.

According to an embodiment, the method may further comprise checking if an end-of-file marker is included at the end of the file; wherein, in case of an end-of-file marker is included, the encrypted data is appended after the end-of-file marker; and wherein, in case of no end-of-file marker is included, an end-of-file marker is created and the encrypted data is appended after the created end-of-file marker.

According to an embodiment, if the encrypted data is decrypted successfully, the file is restored and displayed as it was before encryption.

According to an embodiment, if the encrypted data is not decrypted or not decrypted successfully, the file is displayed as including the predefined data replacing the selected portion.

According to an embodiment, the file is an image file or a document file.

According to an embodiment, a plurality of portions of the file are selected, and each of the plurality of portions is encrypted and replaced separately, so that each of plurality of portions is able to be decrypted separately.

According to an embodiment, the amended file is able to be selectively transmitted as a whole from a start of the amended file to an end of the amended file or from a start of the amended file to where the appended encrypted data starts.

According to another aspect, a device for processing a file comprises a processor; and a memory for storing computer-readable instructions, wherein, when the instructions are executed by the processor, the processor performs the method of the method for processing the image as mentioned above.

According to another aspect, a computer-readable storing medium storing computer-readable instructions is further provided, wherein, when the instructions are executed by a processor, the processor performs the method of the method for processing the image as mentioned above.

In certain embodiments, a system for selectively encrypting and decrypting a portion of a file includes a processor and a memory storing instructions. The instructions, when executed by the processor, perform a series of operations. The processor may select a portion of the file to be encrypted to make a selected portion, replace the selected portion of the file with predefined data, encrypt the selected portion of the file as encrypted data, store the encrypted data in a non-viewable or non-printable area of the file. The processor may also retrieve the encrypted data from the non-viewable or non-printable area of the file, decrypt the encrypted data to make decrypted data, and replace the predefined data in the file with the decrypted data, wherein the decrypted data includes original content of the file in the selected portion.

In certain embodiments, a method for encrypting a selected portion of a file may include extracting a part or section from the file and replacing the extracted part or section with a user-defined text or pixel. The extracted part or section may be encrypted using a user-defined password. The encrypted part or section may be stored in a non-viewable or non-printable area of the file.

In certain embodiments, a method for decrypting an encrypted section of a file may include retrieving the encrypted section from a non-viewable or non-printable area of the file. The encrypted section may then be decrypted using a user-defined password. The user-defined text or pixels may be replaced in the file with an original content from the decrypted section.

### BRIEF DESCRIPTION OF DRAWINGS

FIG. 1 illustrates a method for processing the file according to an embodiment of the present application.

FIG. 2 illustrates a method for processing the file according to another embodiment of the present application.

FIGS. 3a to 3f illustrate examples of the structure of a file before and after being processed according to an embodiment of the present application.

FIG. 4 illustrates a method for displaying the final resultant file generated according to an embodiment of the present application.

FIG. 5 is a block diagram illustrating a device for implementing the method according to an embodiment of the present application.

FIG. 6 is a block diagram illustrating a system for selectively encrypting and decrypting a part or section of a document or file, according to an embodiment of the present disclosure.

FIG. 7 depicts a flowchart illustrating a method for encrypting a part or section of a document or file, according to an embodiment of the present disclosure.

FIG. 8 depicts a flowchart illustrating a method for encrypting a part or section of a of a document or file, according to an embodiment of the present disclosure.

FIG. 9 depicts a flowchart illustrating a method for encrypting a part or section of a of a document or file, according to an embodiment of the present disclosure.

### DETAILED DESCRIPTION OF EMBODIMENTS

Reference will now be made in detail to some specific embodiments of the application including the best modes contemplated by the inventors for carrying out the invention. Examples of these specific embodiments are illustrated in the accompanying drawings. While the application is described in conjunction with these specific embodiments, it will be understood that it is not intended to limit the application to the described embodiments. On the contrary, it is intended to cover alternatives, modifications, and equivalents as may be included within the spirit and scope of the application as defined by the appended claims. In the following description, numerous specific details are set forth in order to provide a thorough understanding of the present application. The present application may be practiced without some of these specific details. In other instances, well-known process operations have not been described in detail in order not to unnecessarily obscure the present application.

According to an embodiment of the present application, a method for processing a file is provided, which comprises the steps of selecting a portion of the file to be obfuscated; encrypting the selected portion of the file as encrypted data; and amending the file by replacing the selected portion with predefined data and appending the encrypted data at an end of the file. The file may be an image file or a document file. Since the selected portion is replaced with the predefined data, the selected portion will not be displayed without decryption. Since the amended file is not encrypted entirely, the amended file could be displayed without decryption. Since the encrypted data is appended at the end of the file, the amended file can be restored as it was before encryption if the encrypted data is decrypted successfully.

The present technology enables a secure and customizable handling of sensitive document parts by allowing a user to extract, replace, encrypt, and securely store selected sections in various document types, while keeping the encrypted data hidden and ensuring it cannot be viewed or printed during normal usage. In particular, the present technology enables a hiding of encrypted data anywhere in the file/document where it is not visible by the user under normal usage.

In certain embodiments, the present technology may be configured to extract a selected part or section of a document or a Microsoft PowerPoint® slide file, which may contain text or images and replace the extracted parts with user-defined text or pixels, or with random text. The present technology may encrypt the extracted selection using a user-defined password and store the encrypted selection in a non-viewable or non-printable area anywhere in the document.

The present technology may allow a user to extract specific parts or sections of a document. These sections may include both text and images. The extracted sections may then be replaced with user-defined text or pixels, and/or random text generated by the system. For instance, the user can choose to replace the content with a string like “AAAAAAAAAAA” or some other placeholder text. The extracted sections may be encrypted using a password provided by the user in order to ensure security and confidentiality of the extracted content.

The encrypted data may be stored in an area anywhere in the file that may not be viewed or printed during normal usage of the document. This step may involve, for example, embedding the encrypted data within the structure of the document in such a way that it is not readily accessible through standard viewing or printing methods (e.g., hiding data within document properties, metadata, or visual basic application code in a Microsoft® Word/Excel®/PowerPoint® or less accessible parts of the file structure). For example, the encrypted data may be stored in the metadata of a PDF, or embedding it in areas not typically viewed or printed in word processors or spreadsheet programs. In certain embodiments, the encrypted data may be decrypted back to its original form using the user-defined password. This decryption process may include allowing the user to enter the password to access the encrypted data, removing the placeholder text or pixels and replacing them with the original extracted content, and ensuring that the decrypted data is restored to its original place in the document, maintaining the document's integrity.

The present technology may be applied to various types of documents and software, including text documents (e.g., Microsoft®, Word OpenOffice® Writer) where the encrypted data may be embedded in hidden document properties or unviewable and non-printable sections of the file. Spreadsheets (e.g., Microsoft®, Excel®, OpenOffice® Calc), where the encrypted cell data may be stored in hidden sheets or metadata. Presentation slides (e.g., Microsoft® PowerPoint®, OpenOffice® Impress), where the encrypted content may be placed in presentation properties or hidden scripts.

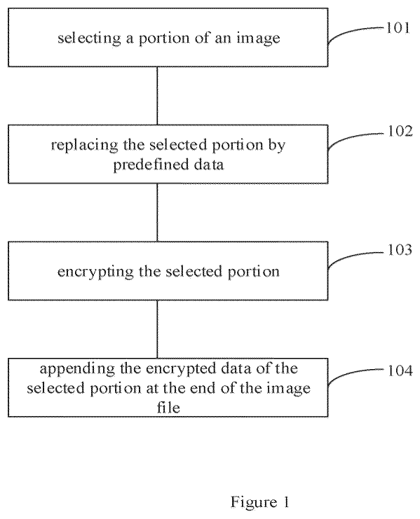

FIG. 1 illustrates a method for processing the file according to an embodiment of the present application. In this embodiment, the file is an image as an example, which may be captured directly or loaded from a storage. It is understood that the file may also be a document. The process to the image is also applicable to the document.

At step 101, at least one portion of the image to be encrypted is selected. The selected portion may be an area that the user does not want other people to view. For example, the selected portion may include sensitive information. The portion may be selected by according to a predefined rule or manually selected by the user.

At step 102, the selected portion of the image is replaced by predefined data. The predefined data may be designated by the user. For example, the predefined data may be pixels in an image, a circle or a box filled with a certain color, an emoji or the like.

The selected portion is encrypted at step 103 and then appended at the end of the image at step 104. The selected portion may be encrypted by any suitable encryption algorithm. An encryption algorithm may be called for encrypting the selected portion. For example, the selected portion may be encrypted by a password, which may also be used for decrypting the encrypted data to recover the selected portion. If more than one encryption algorithms are available, the user may select one of them for encrypting the selected portion. The encrypted data may be appended at the end of the file. For example, the encrypted data may be appended after the end-of-file marker of the file.

Accordingly, the final resultant file includes the unselected portions of the image as original, the predefined data for replacing the selected portion, and the encrypted data of the selected portion at the end of the file. The final resultant file may be stored as a whole in a storage.

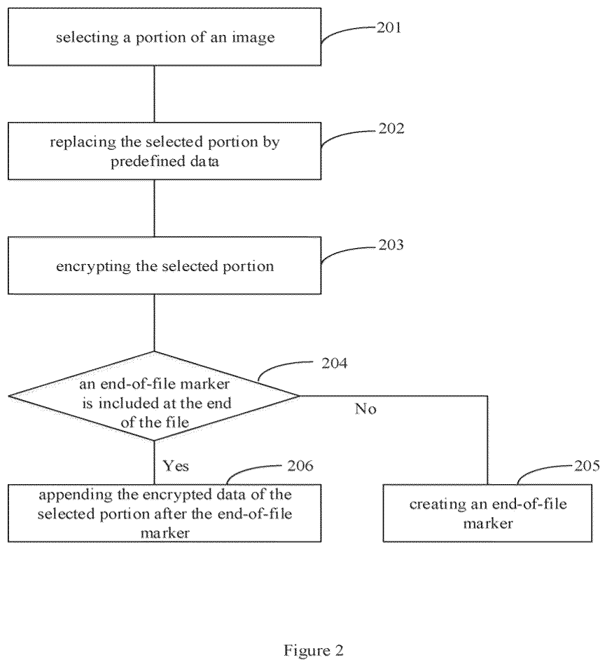

It is understood that the steps 102, 103 and 104 may be implemented in any suitable sequence and also may be implemented in parallel as desired, but are not limited to the sequence shown in FIG. 2.

FIG. 2 illustrates a method for processing the file according to another embodiment of the present application.

At step 201, at least one portion of the image to be encrypted is selected. The selected portion may be an area that the user does not want other people to view. For example, the selected portion may include sensitive information. The portion may be selected by according to a predefined rule or manually selected by the user.

At step 202, the selected portion of the image is replaced by predefined data. The predefined data may be designated by the user. For example, the predefined data may be pixels in an image, a circle or a box filled with a certain color, an emoji or the like.

At step 203, the selected portion is encrypted.

At step 204, it is checked whether an end-of-file marker is included at the end of the file. If it is determined in step 204 that an end-of-file marker is included at the end of the file, the encrypted data is appended after the end-of-file marker of the file at step 206. If it is determined in step 204 that an end-of-file marker is not included at the end of the file, an end-of-file marker is created at step 205 and the encrypted data is appended after the end-of-file marker of the file at step 206.

Accordingly, the final resultant file includes the unselected portions of the image as original, the predefined data for replacing the selected portion, and the encrypted data of the selected portion at the end of the file. The final resultant file may be stored as a whole in a storage.

It is understood that the steps 202, 203 and 204 may be implemented in any suitable sequence or be implemented in parallel as desired, but are not limited to the sequence shown in FIG. 2.

According to an embodiment, when the amended file obtained according to the method as described above is to be transmitted to other users, the file may be selectively transmitted from the start of the amended file to the end of the amended file or from the start of the amended file to where the appended encrypted data starts.

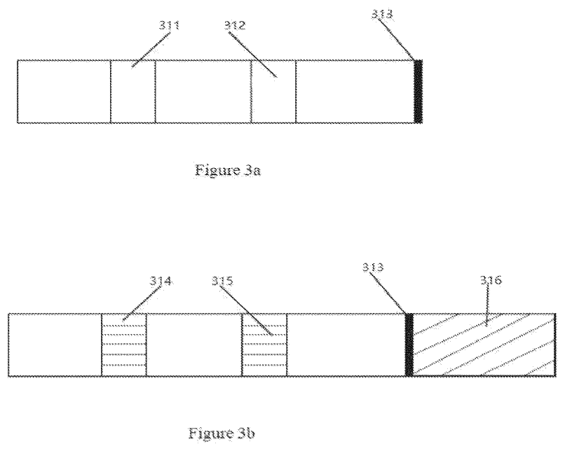

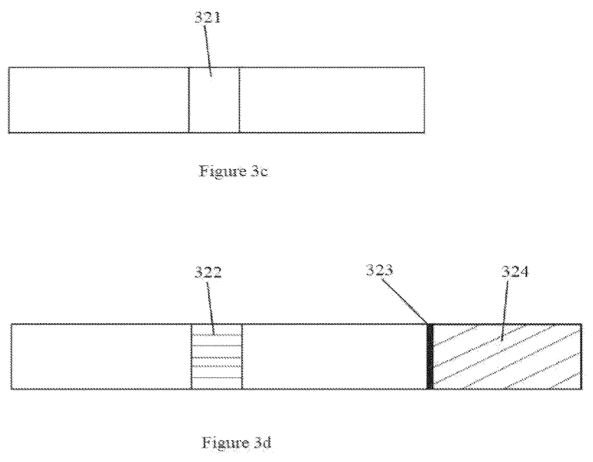

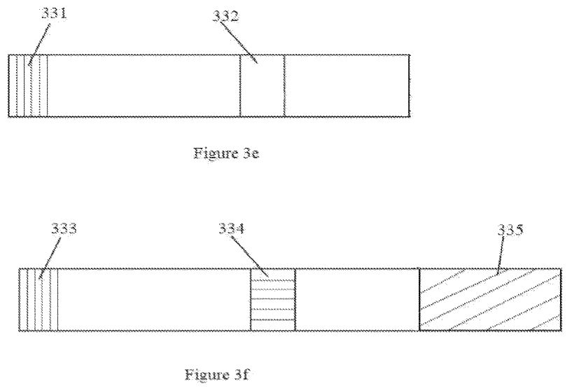

FIG. 3a illustrates an example of the structure of an original file in Jpeg format and FIG. 3b illustrates the file of FIG. 3a with selected portions replaced and encrypted data appended. The file in Jpeg format has an end-of-file marker 313 as shown. For example, if portions 311 and 312 are selected as portions needed to be encrypted and hidden, the portions 311 and 312 may be replaced by data 314 and 315, and encrypted as encrypted data 316 which is then appended after the end-of-file marker 313. When the file of FIG. 3b is read, the content before the end-of-file marker 313 is identified and extracted for displaying as an image. Content associated with the encrypted data 316, i.e., the selected portions 311 and 312, will not be displayed. Instead, the predefined data 314 and 315 are displayed for replacing the selected portions 311 and 312.

Although the encrypted data of portions 311 and 312 are stored as a single portion 316 as shown in FIG. 3b, the portions 311 and 312 may be encrypted separately and the encrypted data of portions 311 and 312 may be stored after the end-of-file marker 313 separately as two portions.

The selected portions 311 and 312 may be encrypted with the same key. Alternatively, the selected portions 311 and 312 may be encrypted with different keys. When the selected portions 311 and 312 are encrypted with different keys, the encrypted data of the portions 311 and 312 must be decrypted separately with different keys. When a first encrypted portion among the encrypted portions is decrypted successfully, the image is displayed as including the original image portion corresponding to the first encrypted portion and the predefined data for replacing the remaining encrypted portions. For example, when the encrypted data of the portion 311 is decrypted successfully but the encrypted data of the portion 312 is not decrypted successfully, the image is displayed as including the selected portion 311 and the predefined data 315 for replacing the portion 312. Accordingly, when different keys are assigned for the encrypted data of different portions, the different keys can be told to different people and thus the different people may have different rights to view some of the encrypted portions. For example, user A may view the image including the decrypted portion A such as the portion 311 and user B may view the image including the decrypted portion B such as the portion 312.

FIG. 3c illustrate an example of the structure of an original file without the end-of-file marker and FIG. 3d illustrates the file of FIG. 3c with selected portions replaced and encrypted data appended. The file as shown in FIG. 3c does not have an end-of-file marker. The portion 321 is selected as a portion needed to be encrypted and hidden. As shown in FIG. 3d, the portion 321 is replaced by predefined data 322 and encrypted as encrypted data 324. An end-of-file marker 323 is created and added at the end of the file, and the encrypted data 324 is appended after the end-of-file marker 323. When the file of FIG. 3d is read, the content before the end-of-file marker 323 is identified and extracted for displaying as an image. Content associated with the encrypted data 324 i.e., the selected portion 321, will not be displayed. Instead, the predefined data 322 is displayed for replacing the selected portion 321.

FIG. 3e illustrate an example of the structure of an original file without the end-of-file marker but have a header indicating the size of the file and FIG. 3f illustrates the file of FIG. 3e with selected portions replaced and encrypted data appended. The file as shown in FIG. 3e does not have an end-of-file marker, but has a hear including a field indicating the size of the file. For example, the image file nay be in the bitmap format. The portion 332 is selected as a portion needed to be encrypted and hidden. As shown in FIG. 3f, the portion 332 is replaced by predefined data 334 and encrypted as encrypted data 335. The header 333 has a field indicating the size of the file in which the portion 332 is replaced by the predefined data 334 without the encrypted data 335. Thus the end of the file, in which the portion 332 is replaced by the predefined data 334 and the encrypted data 335 is not included, is indicated by the header 333 and the encrypted data 335 is appended at the end of the file indicated by the header 333. When the file of FIG. 3f is read, the content before the end of file marker indicated by the header 333 is identified and extracted for displaying as an image. Content associated with the encrypted data 335, i.e., the selected portion 332, will not be displayed. Instead, the predefined data 334 is displayed for replacing the selected portion 321.

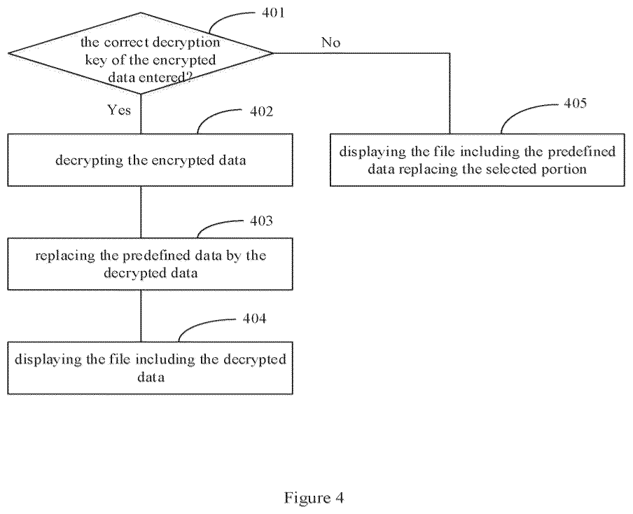

FIG. 4 illustrates a method for displaying the final resultant file generated according to an embodiment of the present application. As mentioned above, the file includes the unselected portions of the image as original, the predefined data for replacing the selected portion, and the encrypted data of the selected portion at the end of the file.

At step 401, it is determined whether the user entered the correct decryption key of the encrypted data. If it is determined at step 401 that the corrected decryption key is entered, the encrypted data of the selected portion is decrypted at step 402. At step 403, the decrypted data of the selected portion is used for replacing the predefined data which has replaced the selected portion in a previous stage. At step 404, the image including the decrypted data such as the original file is displayed. If it is determined at step 401 that the corrected decryption key is not entered, the image is displayed at step 405 as including the unselected portions of the image as original and the predefined data for replacing the selected portion.

It is understood that the file to be processed according to the present application may also be a document. The selected portion of the document to be hidden may be certain word(s), phrase(s), sentence(s), paragraph(s), table(s), numerical value(s) or the like. The selected portion may be encrypted and replaced by predefined data, such as certain symbol(s), character(s), emoji(s), a picture in a certain shape and/or color, or the like. The selected portion may be appended at the end of the file as encrypted data. The processes described with reference to the image file are also applicable to the document file, and thus detailed description thereof is omitted.

The method according to the present application can be implemented by software, firmware, hardware and/or any suitable combination thereof.

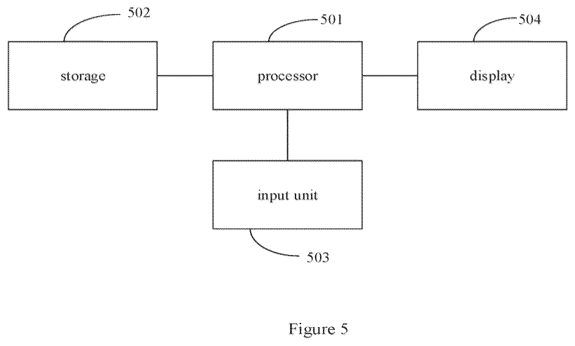

FIG. 5 is a block diagram illustrating a device for implementing the method according to an embodiment of the present application. As shown, the device includes a process 501, a storage 502, an input unit 503 and a display 504. The file to be processed and/or the file after being processed may be stored in the storage 502. The storage 502 may include one or more volatile storage (or memory) devices such as random access memory (RAM), dynamic RAM (DRAM), synchronous DRAM (SDRAM), static RAM (SRAM), or other types of storage devices. The storage 502 may store information including sequences of instructions that are executed by the processor 501 or any other device.

The processor 501 may retrieve a file such as an image or a document from the storage 502, and perform the method according to the present application as described above. For example, the processor 501 may perform the steps 101-104 and/or steps 201-206 as illustrated in FIGS. 1-2. The step of selecting a portion of an image may be performed in response to user's input received from the input unit 503. The final obtained file may be stored into the storage 502 or displayed in the display 504.

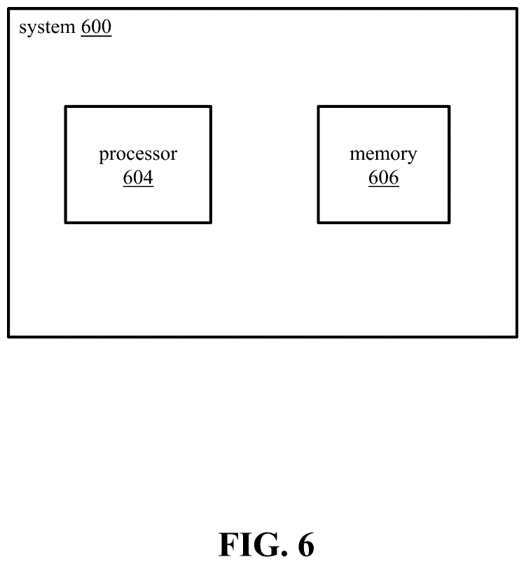

Referring now to FIG. 6, a system 600 for selectively encrypting and decrypting a portion of a file is depicted therein. The system 600 may include a processor 604 and a memory 606. The memory 606 may store processor executable instructions for execution by the processor 604. For example, the processor 604 may be configured to select a portion of a file to be encrypted to make a selected portion. The processor 604 may then replace the selected portion of the file with predefined data and encrypt the selected portion of the file as encrypted data. The encrypted data may be stored in a non-viewable or non-printable area of the file. The encrypted data may be retrieved from the non-viewable or non-printable area of the file. The encrypted data may be decrypted to make decrypted data. The predefined data in the file may be replaced with the decrypted data. The decrypted data may include original content of the file in the selected portion.

In certain embodiments, the file may include a document, spreadsheet, presentation, or PDF file. The predefined data may include user-defined text, pixels, or random text. The non-viewable or non-printable area may metadata of the file. For example, the non-viewable or non-printable area may include metadata of the file or a Visual Basic Module in a Microsoft® Office document. In certain embodiments, the instructions further cause the processor to encrypt the selected portion using a user-defined password and decrypt the encrypted data using the user-defined password. The instructions may also further cause the processor to restore the decrypted data to its original location in the file upon successful decryption.

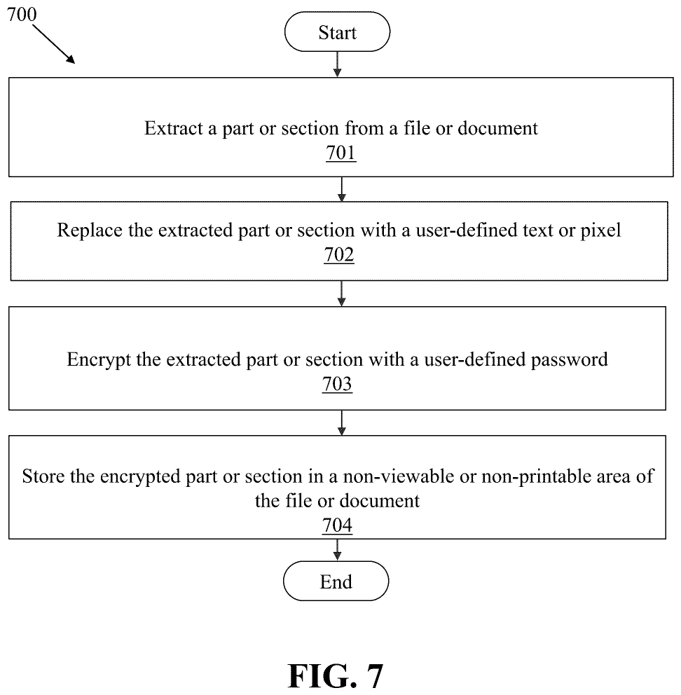

FIG. 7 is a flowchart that describes a method 700 for encrypting a selected portion of a file, using a system 600, such as described above. In a first step 701, the method may include extracting a part or section from the file. In the step 702, the extracted part or section may be replaced with a user-defined text or pixel. In the step 703, the extracted part or section may be encrypted using a user-defined password. Then, in the step 704, the encrypted part or section may be stored in a non-viewable or non-printable area of the file.

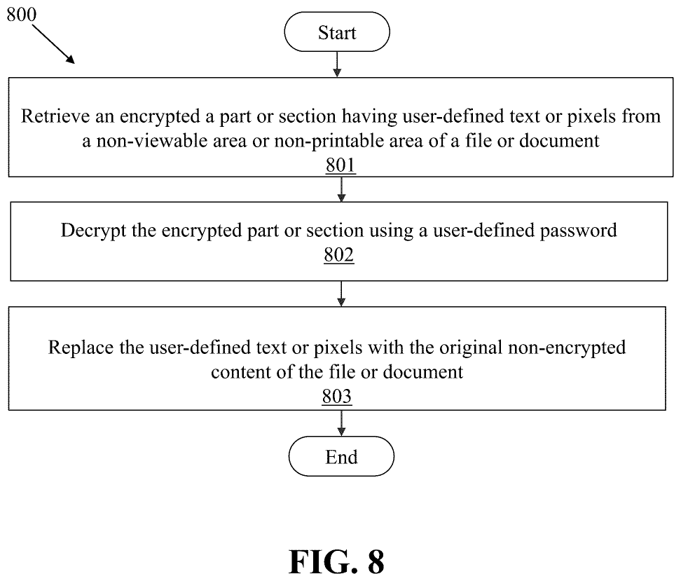

FIG. 8 is a flow chart that describes method 800 for decrypting an encrypted section of a file, using a system 600, such as described above. In a first step 801, the method may include retrieving the encrypted section from a non-viewable or non-printable area of the file. In the step 802, decrypting the encrypted section may be decrypted using a user-defined password. Then, in the step 803, the user-defined text or pixels in the file may be replaced with original content from the decrypted section.

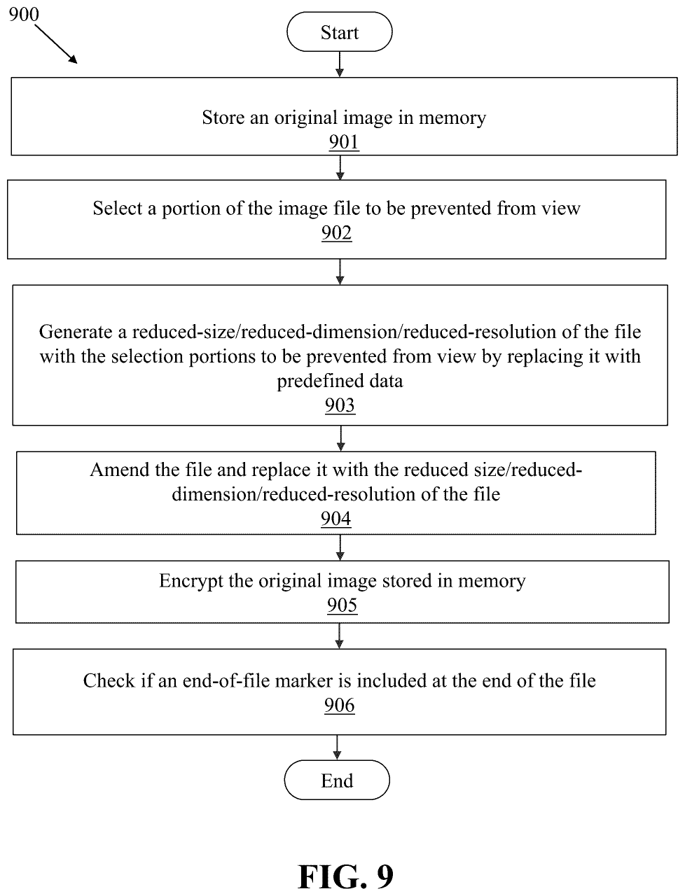

FIG. 9 is a flow chart that describes a further method 900 for decrypting an encrypted section of a file, using a system 600, such as described above. In a first step 901, the method may include storing an original image in memory. Then in the step 902, portions of the image file may be selected to be prevented from view, and in the step 903, a Generate a reduced-size/reduced-dimension/reduced-resolution of the file with the selection portions to be prevented from view by replacing it with predefined data may be generated. This may include for example, a thumbnail file) with the selection portions to be prevented from view replaces with predefined data, such as black pixels or other appropriate predefined data.

In the step 904, the file may be amended by replacing it with the image including the reduced size/reduced-dimension/reduced-resolution of the file, such as described in the step 903. Then, in the step 905, the original image from the step 901, stored in memory may be encrypted and in the step 906 the method may further include checking if an end-of-file marker is included at the end of the file. In particular, if the end-of-file marker is included, the encrypted data is appended after the end-of-file marker; and wherein, if the end-of-file marker is not included, the end-of-file marker is created, and the encrypted data is appended after the created end-of-file marker. In particular, the entire image may be encrypted and put at the end of the file and the part, which is visible, for example, the portion which has the selected portions may be replaced with predefined data may be a smaller resolution or different dimensions.

### EXAMPLES

Example embodiments of the present technology are provided with reference to the FIGS. enclosed herewith, and in particular FIGS. 6-8.

### Example 1: MS Word/OpenOffice Writer

Specific lines may be extracted from the document, where the lines may be replaced with text or pixels, such as “AAAAAAAAAAA.” The contents of the lines may be encrypted and stored in hidden and non-printable areas of the document properties or structure, ensuring they cannot be viewed or printed during normal usage. The data may be later decrypted by entering a password, restoring the original content to the document.

### Example 2: Portable Document Format (PDF)

The encrypted data from an extracted section may be stored in metadata of the document. The encrypted data may not be seen when the document is opened normally in a PDF reader but might be seen in a properties section. The encrypted data may not be viewed or printed during normal usage. The data may be later decrypted by entering the password, restoring the original content to the document.

### Example 3: Microsoft® Excel®/OpenOffice® Calc

A selected range of cells may be extracted and replaced with placeholder text or pixels. The encrypted cell data may be stored in hidden sheets or metadata, thus ensuring it may not be viewed or printed during normal usage. The data may be later decrypted by entering the password, restoring the original content to the document.

### Example 4: Microsoft® PowerPoint®/OpenOffice® Impress

Certain slides or text with slides may be extracted and be replaced with placeholder text or pixels. The encrypted slide content may be stored in metadata or hidden points within the file, ensuring it cannot be viewed or printed during normal usage. The data may later be decrypted by entering the password, restoring the original content to the document.

Although some embodiments of the present application have been described, those skilled in the art can make variations or modifications to these embodiments upon knowing the basic inventive concept. Although details of the embodiments are described, it is understood that it is not necessary to include all elements in the described embodiments. Instead, some elements in the embodiments could be omitted or altered, without departing from the invention. The appended claims are intended to be considered as comprising the described embodiments and all the variations or modifications fell into the scope of the present application.

What is claimed is:

1. A system for selectively encrypting and decrypting a portion of a file, comprising:
a processor; and
a memory storing instructions that, when executed by the processor, cause the processor to:
select a portion of the file to be encrypted to make a selected portion;
replace the selected portion of the file with predefined data;
encrypt the selected portion of the file as encrypted data;
store the encrypted data in a non-viewable or non-printable area of the file;
retrieve the encrypted data from the non-viewable or non-printable area of the file;
decrypt the encrypted data to make decrypted data; and
replace the predefined data in the file with the decrypted data, wherein the decrypted data includes original content of the file in the selected portion.

2. The system of claim 1, wherein the file includes a document, spreadsheet, presentation, or PDF file.

3. The system of claim 1, wherein the predefined data includes user-defined text, pixels, or random text.

4. The system of claim 1, wherein the non-viewable or non-printable area includes metadata of the file.

5. The system of claim 1, wherein the non-viewable or non-printable area includes metadata of the file or a Visual Basic Module in a Microsoft Office document.

6. The system of claim 1, wherein the instructions further cause the processor to encrypt the selected portion using a user-defined password and decrypt the encrypted data using the user-defined password.

7. The system of claim 1, wherein the instructions further cause the processor to restore the decrypted data to its original location in the file upon successful decryption.

8. A method for encrypting a selected portion of a file, comprising:
extracting a part or section from the file;
replacing the extracted part or section with a user-defined text or pixel;
encrypting the extracted part or section using a user-defined password; and
storing the encrypted part or section in a non-viewable or non-printable area of the file.

9. The method of claim 8, wherein the file includes a document, spreadsheet, presentation, or PDF file.

10. The method of claim 8, wherein the non-viewable or non-printable area includes metadata of the file.

11. The method of claim 8, wherein the non-viewable or non-printable area includes a Visual Basic Module in a Microsoft Office document.

12. The method of claim 8, further comprising allowing selective transmission of the file with or without the encrypted selection.

13. The method of claim 8, further comprising allowing decryption of the encrypted selection using the user-defined password.

14. The method of claim 13, further comprising restoring the decrypted selection to its original location in the file upon successful decryption.

15. A method for decrypting an encrypted section of a file, comprising:
retrieving the encrypted section from a non-viewable or non-printable area of the file;
decrypting the encrypted section using a user-defined password; and
replacing user-defined text or pixels in the file with an original content from the decrypted section.

16. The method of claim 15, wherein the file includes a document, spreadsheet, presentation, or PDF file.

17. The method of claim 15, wherein the non-viewable or non-printable area includes metadata of the file.

18. The method of claim 15, wherein the non-viewable or non-printable area includes a Visual Basic Module in a Microsoft Office document.

19. The method of claim 15, further comprising verifying the user-defined password before decrypting the section.

20. The method of claim 15, further comprising allowing selective access to different encrypted portions of the file based on different user-defined passwords.
